(19) United States
(12) Patent Application Publication
(10) Pub. No.: US 2026/0289561 A1
(43) Pub. Date: Sep. 24, 2026

(54) SHIELD-UP SYSTEM AND METHOD FOR PAYMENT TRANSACTIONS

(71) Applicant: Visa International Service Association, San Francisco, CA (US)

(72) Inventors: MRUDUL UCHIL, Bangalore (IN); SHAKTI NILESH, Bangalore (IN)

(73) Assignee: Visa International Service Association, San Francisco, CA (US)

(21) Appl. No.: 19/474,151

(22) PCT Filed: May 9, 2023
(86) PCT No.: PCT/US23/21593

§ 371 Date: Oct. 9, 2025

(51) Int. Cl. G06Q 20/40; G06Q 20/32

(52) U.S. Cl. CPC G06Q 20/401; G06Q 20/326

(57) ABSTRACT

In some embodiments, a computer-implemented method, includes determining, at a communication device, whether a user of a payment application on the communication device desires additional security underlying the payment application; when the user of the communication device desires the additional security, ascertaining user-specific information from the payment application; generating a frontend security framework specific to the user of the payment application; mapping the frontend security framework to the user-specific information; and utilizing the frontend security framework to secure a payment transaction conducted using the payment application.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In the rapidly changing digital financial world of today, many new payment systems that utilize new forms of payment interfaces, such as, for example, the unified payments interface (UPI), are becoming accepted modes of exercising payment transactions in varying populations across the globe. However, with the growth of the payment systems, there has been an increase in erroneous and inadvertent payment transactions that have led to the loss of financial value and personal financial data for users of payment applications on the payment systems. As a result, the overall trust in financial ecosystems, such as those based on UPI, has become questionable and created a bitter experience for consumers utilizing the new payment systems. Thus, it is desirable to provide a payment environment that can improve transaction security and provide the trust necessary for a consumer to perform payment transactions.

### BRIEF DESCRIPTION OF THE DRAWINGS

FIG. 1 illustrates a block diagram of a transaction processing system for electronic payment transactions in accordance with some embodiments.

FIG. 2 illustrates a block diagram of a communication device utilized in the transaction processing system of FIG. 1 in accordance with some embodiments.

FIG. 3 is a flow diagram illustrating a payment transaction shield protection method utilized in the communication device of FIG. 2 in accordance with some embodiments.

FIG. 4 illustrates an example implementation of a payment transaction shield utilized in a UPI-based transaction processing system in accordance with some embodiments.

FIG. 5 illustrates an example implementation of a payment transaction shield utilized in a UPI-based transaction processing system in accordance with some embodiments.

FIG. 6 illustrates an example implementation of a payment transaction shield utilized in a UPI-based transaction processing system in accordance with some embodiments.

### DETAILED DESCRIPTION

A description of terms utilized in the description of all or some of the embodiments are described herein.

In some embodiments, the term “server computer” may include a computer or cluster of computers. For example, the server computer may be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

In some embodiments, the term “public/private key pair” may include a pair of linked cryptographic keys generated by an entity. In some embodiments, the public key may be used for public functions such as encrypting a message to send to the entity or for verifying a digital signature which was supposedly made by the entity. In some embodiments, the private key may be used for private functions such as decrypting a received message or applying a digital signature. In some embodiments, a public/private key pair may be referred to as a key pair for identity.

In some embodiments, the public key may be authorized by a body known as a certification authority (CA), which may store the public key in a database and distributes it to any other entity which requests it. In some embodiments, the certification authority may be included in a payment processing network. The private key may be kept in a secure storage medium and usually only be known to the entity. However, the cryptographic systems described herein may feature key recovery mechanisms for recovering lost keys and avoiding data loss.

In some embodiments, a “digital signature” may refer to the result of applying an algorithm based on a public/private key pair, which allows a signing party to manifest, and a verifying party to verify, the authenticity and integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party.

In some embodiments, a “certificate” may include an electronic document or data file that uses a digital signature to bind a public key with data associated with an identity. The certificate may include one or more data fields, such as the legal name of the identity, a serial number of the certificate, a valid-from and valid-to date for the certificate, certificate-related permissions, etc. A certificate may contain a “valid-from” date indicating the first date the certificate is valid, and a “valid-to” date indicating the last date the certificate is valid. A certificate may also contain a hash of the data in the certificate including the data fields. Unless otherwise noted, each certificate may be signed by a certificate authority.

In some embodiments, a “certificate authority” may include one or more server computers operatively coupled to issue certificates to entities. The certificate authority may prove its identity using a certificate authority certificate, which includes the public key of the certificate authority. The certificate authority certificate may be signed by another private key of the certificate authority or may be signed by the same private key of the certificate authority. The latter is known as a self-signed certificate. In some embodiments, the certificate authority may also maintain a database of all certificates issued by the certificate authority.

In some embodiments, the certificate authority may be configured to receive an unsigned certificate from an entity whose identity is known. In some embodiments, the unsigned certificate includes a public key, one or more data fields, and a hash of the data in the certificate. In some embodiments, the certificate authority signs the certificate with a private key corresponding to the public key included on the certificate authority certificate. In some embodiments, the certificate authority may then store the signed certificate in a database, and issue the signed certificate to the entity.

In some embodiments, a device may be configured with one or more “trusted root certificate authorities” (trusted root CAs). In some embodiments, a trusted root certificate authority is a certificate authority whose certificate is self-signed, and which a device trusts independently. Examples entities which operate trusted root certificate authorities may include Visa®, Mastercard®, Verisign®, and Thawte®.

In some embodiments, a certificate may be “verified” by verifying the signature of the certificate and verifying the certificate of the certificate authority that signed the certificate. In some embodiments, the signature of a certificate may be verified by decrypting the signature using the public key associated with the certificate authority. In some embodiments, the decrypted value is compared to an expected value based on the contents of the certificate. In some embodiments, if the values are the same, the signature is verified. In some embodiments, each subsequent certificate authority certificate is verified in a similar manner, until a trusted root certificate authority is reached, or until a certificate cannot be verified. In some embodiments, the sequence of certificates from a certificate to be verified to the trusted root certificate authority is known as a “certificate chain”.

A “token” may include any identifier for a payment account that is a substitute for an account identifier. For example, a token may include a series of alphanumeric characters that may be used as a substitute for an original account identifier. For example, a token “4900 0000 0000 0001” may be used in place of a primary account identifier or primary account number (PAN) “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction or represent the original credential in other systems where the original credential may be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Authentication” is a process by which the credential of an endpoint (including but not limited to applications, people, devices, processes, and systems) can be verified to ensure that the endpoint is who they are declared to be.

An “original” transaction may include any transaction including an authorization provided by an issuer or an authorization provided on-behalf-of an issuer.

A “substitute” transaction may be any transaction that is associated with an original transaction and that takes place after the original transaction, including repeat, refunds, reversals or exceptions (chargebacks, re-presentments, etc.).

An “end-user” may include any application, device, consumer, or system that is configured to interact with a requestor for tokenization/de-tokenization/token management services. For example, an end-user may include a consumer, a merchant, a mobile device, or any other suitable entity that may be associated with a requestor in the network token system.

In some embodiments, a “consumer” may include an individual or a user that may be associated with one or more personal accounts, consumer devices, and/or communication devices. The consumer may also be referred to as a cardholder, accountholder, or user.

A “card-on-file (COF)” holder may include any entities that store account details (e.g., card details, payment account identifiers, PANs, etc.) for use in transactions. For example, a COF entity may store payment information on file for various types of periodic payments such as monthly utility payments, periodic shopping transactions, or any other periodic or future transaction. Because payment credentials and/or associated tokens are stored at an entity for a future transaction, the transactions initiated by a COF entity include card-not-present (CNP) transactions. Another type of card-not-present (CNP) transaction includes e-commerce or electronic commerce transactions that are initiated between remote parties (e.g., a consumer device and a merchant web server computer).

An “authorization request message” may be an electronic message that is sent to a payment processing network and/or an issuer of a payment account to request authorization for a transaction. An authorization request message according to some embodiments may comply with ISO 8583, which is a standard for systems that exchange electronic transaction information associated with a payment made by a consumer using a payment device or a payment account. In some embodiments, an authorization request message may include a payment token, an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include an authorization code, which may be a code that a credit card issuing bank returns in response to an authorization request message in an electronic message (either directly or through the payment processing network). As noted above, in some embodiments, a payment processing network may generate or forward the authorization response message to the merchant.

In some embodiments, “machine readable code” can be any encoded image readable by a communication device or any other computing device. The machine readable code can be read by a device by, e.g., scanning the code with a camera device that is part of, or attached to, the device. Examples of machine readable code including quick response codes and SnapTags.

A “cryptogram” may be a uniquely signed digital payload associated with a primary account number (PAN) or token. The cryptogram may uniquely identify the device that emulated the payment card and is a form of validation. The cryptogram may be uniquely generated for every payment transaction.

In some embodiments, “financial credentials” may include a PAN, token, or any other representation that identifies a payment account associated with a user.

In some embodiments, a “secure element” may be a dynamic environment in which application code and application data can be securely stored and administered and which secure execution of applications occur. In some embodiments, the secure element may reside in highly secure crypto chips. In some embodiments, the financial credentials can be stored within the secure element.

In some embodiments, an “access computer” may be a computer that enables a customer to access a QR code to make a payment to, for example, a merchant or content provider, in exchange for goods or services. In some embodiments, an access computer may include hardware, software, or a combination thereof, used to display the QR code that may be scanned by a user of a communication device to initiate a transfer of funds from the user to a banking account associated with the merchant or end-entity, such as, for example, a provider of content on a content platform.

In some embodiments, an end-entity is an entity (e.g., an organization or person) that is the ultimate recipient of a payment or transfer of funds. In some embodiments, the end-entity may be considered a final link in the chain of transactions performed utilizing the transaction processing system 100.

In some embodiments, a “digital wallet provider” may include any suitable entity that provides a digital wallet service. A digital wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the digital wallet.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

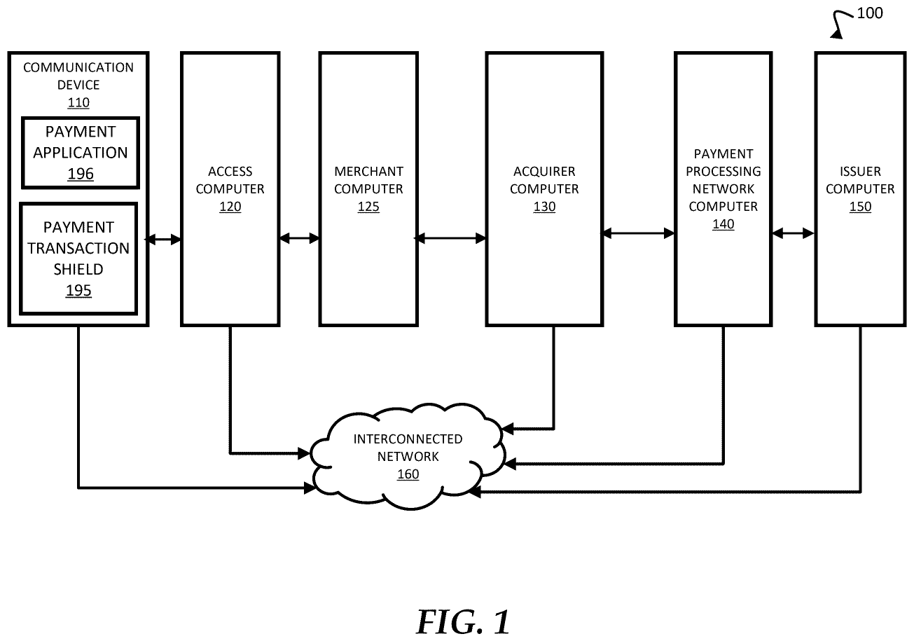

FIG. 1 illustrates a block diagram of a transaction processing system 100 in accordance with some embodiments. In some embodiments, the transaction processing system 100 is configured to utilize a payment transaction shield 195 on a communication device 110 to protect a user associated with a payment application 196 from unauthorized or unintended payment transactions conducted using the payment application 196. In some embodiments, the communication device 110 utilizes a payment transaction shield generator to generate the payment transaction shield 195 underlying the payment application 196. In some embodiments, the payment transaction shield 195 utilizes a frontend security framework at the communication device 110 to prevent the unauthorized payment transactions from occurring on payment application 196. In some embodiments, the payment transaction shield 195 is local to the user of the payment application 196 and is configured to add additional security to the payment application 196, which may be, for example, a Unified Payments Interface (UPI)-based payment application.

In some embodiments, the transaction processing system 100 may be, for example, a UPI-based system configured to process payment transactions using a UPI-based payment application. In some embodiments, the transaction processing system 100 may include a communication device 110, an access computer 120, a merchant computer 125, an acquirer computer 130, a payment processing network computer 140 and an issuer computer 150. In some implementations, different entities in FIG. 1 may communicate with each other using one or more communication networks such as the Internet, a cellular network, a TCP/IP network or any other suitable communication network. Note that one or more entities in the transaction processing system 100 may be associated with a computer apparatus that may be implemented using some of the components described herein.

In some embodiments, the communication device 110 may be associated with a payment account of a user of the communication device 110. In some embodiments, the communication device 110 may be a mobile device, such as a mobile phone, a tablet, a PDA, a notebook, a key fob, a mobile watch, or any suitable mobile device. For example, the communication device 110 may include a wallet or a payment application that may be associated with one or more payment accounts of the user. In some implementations, the communication device 110 may be configured to display a machine readable code, such as, for example, QR code. In some embodiments, the communication device 110 may also include a camera or a scanning device capable of scanning machine readable code. In some embodiments, the communication device 110 is configured to scan a QR code displayed on, for example, access computer 120. In some implementations, the communication device 110 may be capable of communicating with the access computer 120 via the internet. In some implementations, the communication device 110 may be associated with a payment card such as a credit card, debit card, prepaid card, loyalty card, gift card, etc.

In some implementations, the access computer 120 may be a personal computer that may be used by the user to initiate a transaction with the merchant computer 125 (e.g., an online transaction). In some implementations, the access computer 120 may be configured to display transaction information in a format that may be read by the communication device 110 (e.g., mobile phone).

In some embodiments, the merchant computer 125 may be associated with a merchant that may be an end-entity. In some embodiments, the merchant computer 125 may be associated with a card-on-file (COF) merchant. For example, the card-on-file merchant may store consumer account information on file (e.g., at a merchant database) for future payment purposes such as various types of periodic payments (e.g., monthly utilities payments). In some implementations, a consumer may register with one or more merchants for card-on-file services. The merchant computer 125 may be configured to generate an authorization request for a transaction initiated by the user using the QR code displayed on the access computer 120.

In some embodiments, the acquirer computer 130 may represent an acquirer/acquirer processor. In some embodiments, the acquirer computer 130 is a system for an entity (e.g., a bank) that has a business relationship with a particular merchant, a wallet provider or another entity. In some embodiments, the acquirer computer 130 may be communicatively coupled to the merchant computer 125 and the payment processing network computer 140 and may issue and manage a financial account for the merchant. In some embodiments, the acquirer computer 130 may be configured to route the authorization request for a transaction to the issuer computer 150 via the payment processing network computer 140 and route an authorization response received via the payment processing network computer 140 to the merchant computer 125.

In some embodiments, the payment processing network computer 140 may be configured to provide authorization services, and clearing and settlement services for payment transactions. In some embodiments, the payment processing network computer 140 may include data processing subsystems, wired or wireless networks, including the internet. An example of the payment processing network computer 140 includes VisaNet™, operated by Visa®. Another example of a payment processing network in a UPI-based transaction processing system is the UPI, operated by the National Payments Corporation of India (NPCI). Payment processing networks, such as, for example, VisaNet™ are configured to process credit card transactions, debit card transactions, and other types of commercial transactions. VisaNet™, in particular includes a Visa Integrated Payments (VIP) system which processes authorization requests and a Base II system which performs clearing and settlement services. The payment processing network computer 140 may include a server computer. In some implementations, the payment processing network computer 140 may forward an authorization request received from the acquirer computer 130 to the issuer computer 150 via a communication channel. In some embodiments, the payment processing network computer 140 may further forward an authorization response message received from the issuer computer 150 to the acquirer computer 130. In some embodiments, the payment processing network computer 140 may include the certificate authority, where the certificate authority is configured to generate a root certificate, an intermediate certificate, etc., requested by acquirer computer 130.

In some embodiments, the issuer computer 150 may represent an account issuer and/or an issuer processor. In some embodiments, the issuer computer 150 may be associated with a business entity (e.g., a bank) that may have issued an account and/or payment card (e.g., credit account, debit account, etc.) for payment transactions. In some implementations, the business entity (bank) associated with the issuer computer 150 may also function as an acquirer (e.g., the acquirer computer 130).

The various entities in the transaction processing system 100 may communicate with each other via an interconnected network 160, e.g., the Internet.

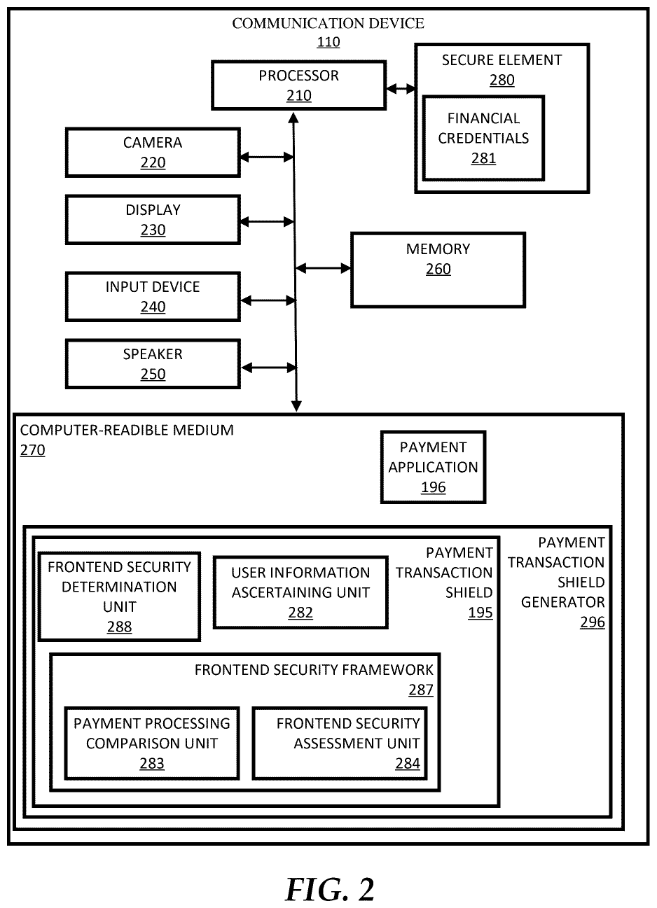

FIG. 2 illustrates a block diagram of communication device 110 in accordance with some embodiments. In some embodiments, the communication device 110 includes a payment transaction shield generator 296 that is configured to generate a payment transaction shield 195 to protect the user of a payment application 196 from unauthorized payment transactions conducted utilizing payment application 196. In some embodiments, the payment application 196, may be, for example, a UPI-based payment application that is utilized to conduct payment transactions utilizing communication device 110. In some embodiments, as stated previously, the user of the communication device 110 may utilize the payment transaction shield 195 for additional payment transaction security underlaying the payment application 196 (e.g., a UPI-based payment application).

In some embodiments, communication device 110 includes a processor 210, a camera 220, a display 230, an input device 240, a speaker 250, a memory 260, a computer-readable medium 270, and a secure element 280. In some embodiments, the computer-readable medium 270 includes the payment application 196 and the payment transaction shield generator 296. In some embodiments, the payment transaction shield generator 296 is executable code configured to generate the payment transaction shield 195 that includes a frontend security determination unit 288, a user information ascertaining unit 282, and a frontend security framework 287.

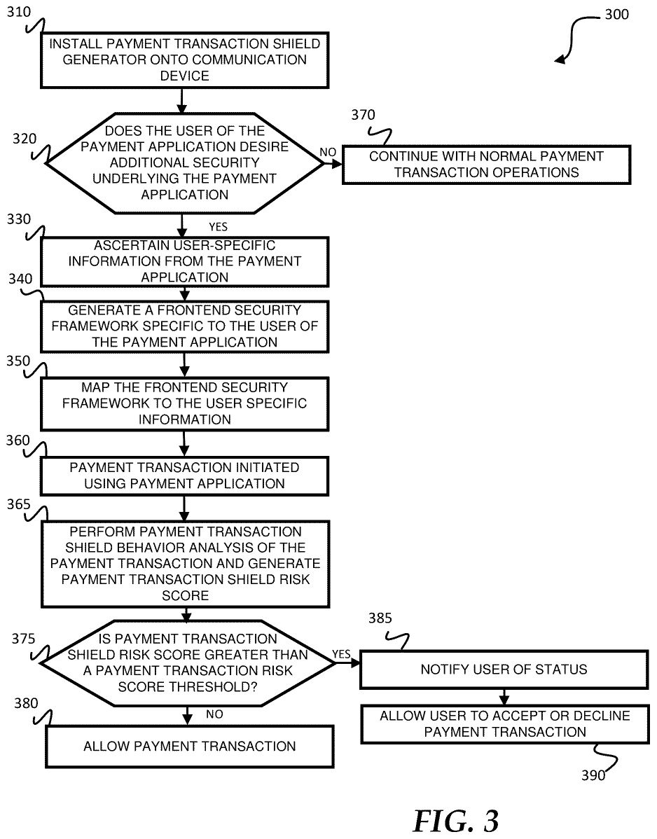

In some embodiments, the frontend security determination unit 288 is executable code configured to determine whether the user of the payment application 196 desires additional security (e.g., the payment transaction shield 195) underlying the payment application 196. In some embodiments, the user information ascertaining unit 282 is executable code configured to ascertain user-specific information associated with the user of the communication device 110 and the payment application 196. In some embodiments, the frontend security framework 287 is executable code configured to perform a frontend security assessment of payment transactions conducted utilizing payment application 196. In some embodiments, the frontend security framework 287 includes a frontend payment transaction comparison unit 283 and a frontend security assessment unit 284. In some embodiments, the frontend security assessment unit 284 is executable code configured to perform a behavior analysis of the user/user device (e.g., behavior associated with payment transactions conducted by the user) and generate a payment transaction shield risk score associated with the behavior. In some embodiments, the frontend payment transaction comparison unit 283 is executable code configured to compare the payment transaction shield risk score to a payment transaction shield risk score threshold to determine whether to authorize a payment transaction conducted using the payment application 196 (as described further in detail with reference to FIG. 3).

In some embodiments, with further reference to FIG. 2, processor 210 may be any suitable processor operable to carry out instructions on the communication device 110. The processor 210 is coupled to other units of the communication device 110 including camera 220, display 230, input device 240, speaker 250, memory 260, computer-readable medium 270, and secure element 280.

Camera 220 may be configured to capture one or more images via a lens located on the body of communication device 110. The captured images may be still images or video images. The camera 220 may include a CMOS image sensor to capture the images. Various applications (e.g., payment application 196) running on processor 210 may have access to camera 220 to capture images. It can be appreciated that camera 220 can continuously capture images without the images actually being stored within communication device 110. Captured images may also be referred to as image frames. In some embodiments, camera 220 may be configured to capture images of a machine readable code, such as, for example, a QR code.

Display 230 may be any device that displays information to a user. Examples may include an LCD screen, CRT monitor, or seven-segment display.

Input device 240 may be any device that accepts input from a user. Examples may include a keyboard, keypad, mouse, or microphone. In the case of a microphone, the microphone may be any device that converts sound to an electric signal. In some embodiments, the microphone may be used to capture one or more voice segments from a user.

Speaker 250 may be any device that outputs sound to a user. Examples may include a built-in speaker or any other device that produces sound in response to an electrical audio signal. In some embodiments, speaker 250 may be used to request the user for a voice sample for purposes of authentication.

Memory 260 may be any magnetic, electronic, or optical memory. It can be appreciated that memory 260 may include any number of memory modules. An example of memory 260 may be dynamic random access memory (DRAM). In some embodiments, the memory 260 may include an operating system during, for example, operation of communication device 110.

Computer-readable medium 270 may be any magnetic, electronic, optical, or other computer-readable storage medium. Computer-readable medium 270 may comprise any combination of volatile and/or non-volatile memory such as, for example, buffer memory, RAM, DRAM, ROM, flash, or any other suitable memory device, alone or in combination with other data storage devices.

In some embodiments, with further reference to FIG. 2, a trust store may refer to a repository of trusted certificate authorities that is used by communication device 110 to verify the authenticity of digital certificates associated with merchants, payment gateways, or other entities involved in online transactions with communication device 110. In some embodiments, a trust store may include the public keys of the trusted certificate authorities and may be used by clients (such as web browsers or payment applications) to verify the identity of servers. In some embodiments, the trust store may include the root certificates and intermediate certificates of trusted certificate authorities that are authorized to issue digital certificates for merchants, payment gateways, and other entities involved in a transaction. In some embodiments, the trust store may be used by a QR code scanning application to verify the authenticity of a certificate a when establishing a secure connection with the payment gateway in transaction processing system 100.

In some embodiments, secure element 280 may be a secure, tamper-resistant, storage and execution environment that stores various payment assets such as financial credentials 281. In some embodiments, the secure element 280 may be composed of a combination of an integrated circuit and an operating system. In some embodiments, the secure element 280 may also contain a secure applet that may be selected by the access computer 120 and presents any available mobile contactless payment information to the access computer 120.

In some embodiments, payment application 196 may be an application executable by processor 210 on the communication device 110. In some embodiments, the payment application 196 may be an application for facilitating payment transactions using the communication device 110. For example, in some embodiments, the payment application 196 may be a UPI-based application.

FIG. 3 is a flow diagram illustrating a payment transaction shield protection method 300 in accordance with some embodiments. In some embodiments, the payment transaction shield protection method 300 is utilized by a user of a payment application 196 to generate a payment transaction shield 195 underlaying the payment application 196. In some embodiments, the payment transaction shield 195 is configured to provide additional security to the user of the payment application 196 to protect and shield the user from unauthorized (or unintentional) payment transactions being conducted on payment application 196. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the payment transaction shield protection method 300 is described with reference to the figures described herein.

In some embodiments, at operation 310, a user installs a payment transaction shield generator 296 onto communication device 110. As stated previously, payment transaction shield generator 296 is executable code configured to generate the payment transaction shield 195 at the communication device 110 and may be in the form of a downloadable “app” or “application” from an application provider or payment processing network computer 140. In some embodiments, after the user installs the payment transaction shield generator 296 onto communication device 110, operation 310 proceeds to operation 320.

In some embodiments, at operation 320, in order to commence the process of generating a payment transaction shield 195, frontend security determination unit 288 of payment transaction shield generator 296 determines, at communication device 110, whether a user of the payment application 196 has requested or desires a payment transaction shield 195 to protect the user from unauthorized payment transactions being conducted on payment application 196. In some embodiments, as stated previously, the payment application 196, may be for example, UPI-based payment application that is utilized to conduct payment transactions via communication device 110 in a UPI-based transaction processing system. In some embodiments, payment transaction shield generator 296 determines whether a user of the payment application 196 has requested a payment transaction shield 195 by assessing input received from a “Request Payment Transaction Shield” prompt provided by the payment transaction shield generator 296 to the user of communication device 110 on display 230. In some embodiments, after the frontend security determination unit 288 determines whether a user of the payment application 196 has requested a payment transaction shield 195, operation 320 proceeds to operation 330 or operation 370.

In some embodiments, when the frontend security determination unit 288 determines that the user of the communication device 110 has not requested the payment transaction shield 195, at operation 370, normal payment transaction processing operations continue on payment application 196 without application of the payment transaction shield 195. In some embodiments, when the frontend security determination unit 288 determines that the user of the communication device 110 has requested the payment transaction shield 195, at operation 330, the user information ascertaining unit 282 of payment transaction shield generator 296 commences the process ascertaining user-specific information associated with the user of the communication device 110. In some embodiments, the user-specific information is payment transaction related information associated with the user of the payment application 196 that is utilized by the payment transaction shield 195 to conduct a behavior analysis of the user to prevent unauthorized or unintended payment transactions. In some embodiments, the user information ascertaining unit 282 ascertains user-specific information from the user of the communication device 110 by downloading a log of previous payment transactions from the payment application 196 and/or bank account associated with the payment application 196. In some embodiments, the user information ascertaining unit 282 ascertains user-specific information by monitoring the use of the payment application 196 by the user. In some embodiments, the use-specific information ascertained by the user information ascertaining unit 282 includes, for example, a spending pattern (amount, frequency, etc.) of the user, commonly used merchants of the user (Person-to-Business), commonly used persons of the user (Person-to-Person (P2P) transactions), a time of the day of payment transactions, a geolocation of the occurrence of the payment transactions, a user or client device footprint, key patterns associated with the user of the payment application 196 on the communication device 110 (strokes, spaces, alignment, etc.), a proximity of a merchant to the user of the communication device 110, transaction caching associated with user payment transactions, identity impersonation information, and a number of failed attempts of a payment transaction associated with the payment application 196. In some embodiments, the use-specific information ascertained by the user information ascertaining unit 282 may include biometric/behavior pattern information, such as, for example, a client device footprint, key patterns associated with the user of the payment application 196 on the communication device 110 (strokes, spaces, alignment, etc.), identity impersonation information, a face ID, and fingerprints. In some embodiments, after ascertaining the user-specific information, operation 330 proceeds to operation 340.

In some embodiments, at operation 340, payment transaction shield generator 296 generates a frontend security framework 287 specific to the user of the payment application 196. In some embodiments, as stated previously, the payment transaction shield generator 296 is executable code configured to generate the payment transaction shield 195 that includes the frontend security determination unit 288, the user information ascertaining unit 282, and the frontend security framework 287. In some embodiments, the frontend security framework 287 includes the: (1) frontend security assessment unit 284 that is executable code configured to perform a behavior analysis of the user/user device (e.g., behavior associated with payment transactions conducted by the user) and generate a payment transaction shield risk score associated with the behavior; and (2) the frontend payment transaction comparison unit 283 that is executable code configured to compare the payment transaction shield risk score to a payment transaction shield risk score threshold to determine whether to authorize a payment transaction conducted using the payment application 196. In some embodiments, the frontend security framework 287 generated by the payment transaction shield generator 296 is configured to monitor the payment transactions of the user of payment application 196 and utilize user-specific information of the user of communication device 110 and payment application 196 to prevent unauthorized payment transactions. In some embodiments, the frontend security framework 287 is part of a shield for the user of the payment application 196 to prevent unauthorized payment transactions from occurring using the payment application 196, as some payment applications may not provide sufficient security to prevent fraudulent transactions from occurring. In some embodiments, after generating the frontend payment transaction comparison unit 283 and the frontend security assessment unit 284 at communication device 110, operation 340 proceeds to operation 350.

In some embodiments, at operation 350, payment transaction shield generator 296 maps the frontend security framework to the user-specific information. In some embodiments, payment transaction shield generator 296 maps the frontend security framework 287 to the user-specific information by associating the user of the payment application 196 with the user-specific information at the payment transaction shield 195. In some embodiments, the payment transaction shield generator 296 associates the user of the payment application 196 with the user-specific information by linking the user-specific information with payment application 196. In some embodiments, after mapping the frontend security framework to the user-specific information, operation 350 proceeds to operation 360.

In some embodiments, at operation 360, a payment transaction is initiated using payment application 196. In some embodiments, the payment transaction may be an unintended payment transaction (e.g., an unintended monetary amount (e.g., accidentally typed monetary amount or an amount that exceeds typical monetary amounts) or an unauthorized payment transaction (e.g., a fraudulent payment transaction from a nefarious user). In some embodiments, after initiation of a payment transaction using payment application 196, at operation 365, the frontend security assessment unit 284 performs a behavior-based analysis of the payment transaction conducted using payment application 196 (as part of a behavior-based authentication) to determine whether the payment transaction conducted using payment application 196 should be authorized or not authorized. In some embodiments, the behavior analysis performed by the frontend security assessment unit 284 is an assessment of the behavior of the user associated with the payment transaction compared to previous behaviors of the user associated with previous payment transactions. In some embodiments, as part of the behavior analysis, the frontend security assessment unit 284 assesses a spending pattern of the user of the communication device 110 to determine whether to allow a payment transaction conducted using the payment application 196. In some embodiments, as part of the behavior analysis, the frontend security assessment unit 284 assesses commonly used merchant of the user of the communication device 110 to determine whether to allow the payment transaction conducted using the payment application 196 (e.g., the merchant is from a list of commonly used merchants by the user). In some embodiments, frontend security assessment unit 284 may utilize a machine learning model (ML) in performing the behavior analysis of the payment transactions made utilizing the payment application 196. For example, in some embodiments, the data elements used to perform the behavior analysis (e.g., data analytics and biometric/behavioral patterns) may be fed into, for example, a ML model to understand the patterns for fraud and error use cases.

In some embodiments, as part of the behavior analysis associated with the payment transaction, the frontend security assessment unit 284 generates the payment transaction shield risk score associated with the behavior of user or user device associated with the payment transaction. In some embodiments, the payment transaction shield risk score is a numerical score generated by the frontend security assessment unit 284 that indicates the level of risk associated with the payment transaction and is utilized by the frontend security assessment unit 284 to determine whether a payment transaction should be approved, declined, or flagged for further review by the user of the communication device 110 and/or the frontend security assessment unit 284. For example, in some embodiments, when a customer utilizes payment application 196 of communication device 110 to make a payment transaction and has a history of making similar types purchases using the payment application 196, with no reported issues or chargebacks, the historical payment transaction shield risk score assigned to the payment transaction by the frontend security assessment unit 284 may be, for example, twenty or some other value indicating that the historical risk a minimal. In some embodiments, for example, when a customer utilizes payment application 196 of communication device 110 to make a payment transaction and does not have a history of making similar purchases using the payment application 196, with reported issues or chargebacks, the historical payment transaction shield risk score assigned to the payment transaction by the frontend security assessment unit 284 may be, for example, eighty or some other value indicating that there is high risk associated with the payment transaction. In some embodiments, after the payment transaction shield risk score is generated by the frontend security assessment unit 284 for the initiated payment transaction, operation 365 proceeds to operation 375.

In some embodiments, at operation 375, the frontend security assessment unit 284 compares the payment transaction shield risk score to a payment transaction shield risk score threshold and designates the payment transaction as either a high risk payment transaction or a low risk payment transaction. In some embodiments, the payment transaction shield risk score threshold is a numerical value that serves as a cutoff point or boundary for high risk payment transactions and low risk payment transactions. In some embodiments, payment transaction shield risk scores that are greater than or equal to the payment transaction shield risk score threshold are designated as being high risk payment transactions and payment transaction shield risk scores that are less than the payment transaction shield risk score threshold are designated as being low risk payment transactions. In some embodiments, after the payment transaction has been designated as either a high risk payment transaction or a low risk payment transaction, operation 375 proceeds to either operation 380 or operation 385.

In some embodiments, when frontend security assessment unit 284 determines that the payment transaction shield risk score is less than the payment transaction shield risk score threshold, at operation 380, the payment transaction is considered an authorized or intended payment transaction and the payment transaction is allowed to proceed by payment transaction shield 195 for payment processing by payment processing network computer 140.

In some embodiments, at operation 385, when frontend security assessment unit 284 determines that the payment transaction shield risk score is greater than or equal to the payment transaction shield risk score threshold, the payment transaction is designated as an unauthorized or unintended payment transaction and the user associated with payment application 196 is notified that the payment transaction conducted using the payment application 196 should not be authorized and, at operation 390, presented with the option of cancelling the payment transaction or proceeding with the payment transaction (e.g., the user of the payment application 196 at communication device 110 is notified to confirm authorization of the payment transaction).

For example, in some embodiments, when the payment transaction shield risk score is greater than or equal to the payment transaction shield risk threshold (indicating high risk or behavior-based authentication failure), the frontend security assessment unit 284 flags the payment transaction for either deterrent control or preventive control. In some embodiments, for deterrent control, the frontend security assessment unit 284, via display 230, alerts the user with a push notification message that notifies the user to be aware of fraud or error in the transaction. In some embodiments, the frontend security assessment unit 284, via display 230, requests the consent of the user to move forward with payment transaction. In some embodiments, for preventive control, the frontend security assessment unit 284 cancels the payment transaction and provides, via display 230, an informational message to the user explaining the reason for cancellation. In some embodiments, the frontend security assessment unit 284 may provide an override functionality that the user may utilize to override and complete the transaction based on step up authentication and verification. In some embodiments, the deterrent control or preventive control operations supplied by the payment transaction shield 195 are configured to protect a UPI-based payment application user from financial fraud-either loss of money or financial data breach.

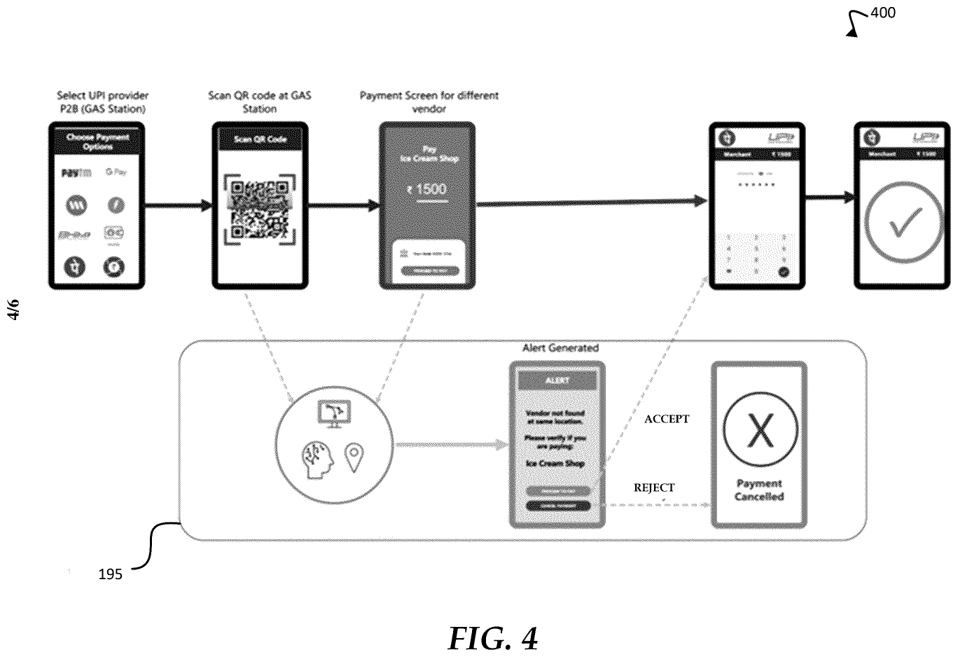

FIG. 4 illustrates an example implementation 400 of a payment transaction shield 195 utilized in a UPI-based transaction processing system 100 in accordance with some embodiments. In the example of FIG. 4, the payment transaction shield 195 generated by the payment transaction shield generator 296 has shielded the user of payment application 196 (e.g., a UPI-based payment application) from a payment transaction occurring at a location of a vendor not found at the same location of the payment application 196 on the communication device 110. The payment transaction shield 195 has notified the user of the payment application 196 to verify the payment transaction by either proceeding with the payment transaction (e.g., “PROCEED TO PAY”) or cancelling the payment transaction (e.g., “CANCEL PAYMENT”).

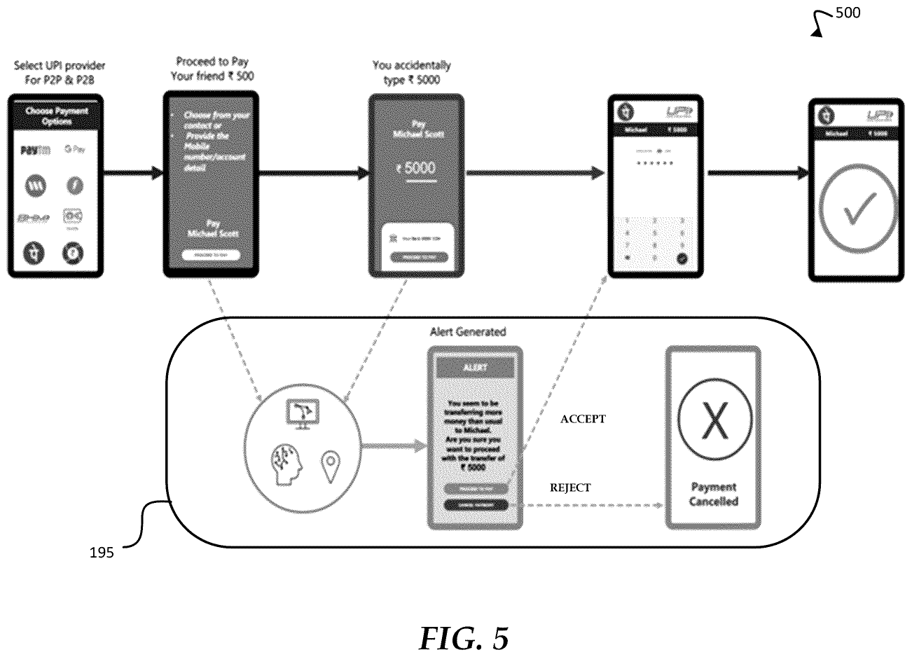

FIG. 5 illustrates an example implementation 500 of a payment transaction shield 195 utilized in a UPI-based transaction processing system 100 in accordance with some embodiments. In the example of FIG. 5, the payment transaction shield 195 generated by the payment transaction shield generator 296 has shielded the user of payment application 196 (e.g., a UPI-based payment application) from a payment transaction occurring based upon an incorrect monetary amount ($5000 versus $500) associated with the payment transaction. The payment transaction shield 195 has notified the user of the payment application 196 to verify the payment transaction by either proceeding with the payment transaction (e.g., “PROCEED TO PAY”) or cancelling the payment transaction (e.g., “CANCEL PAYMENT”).

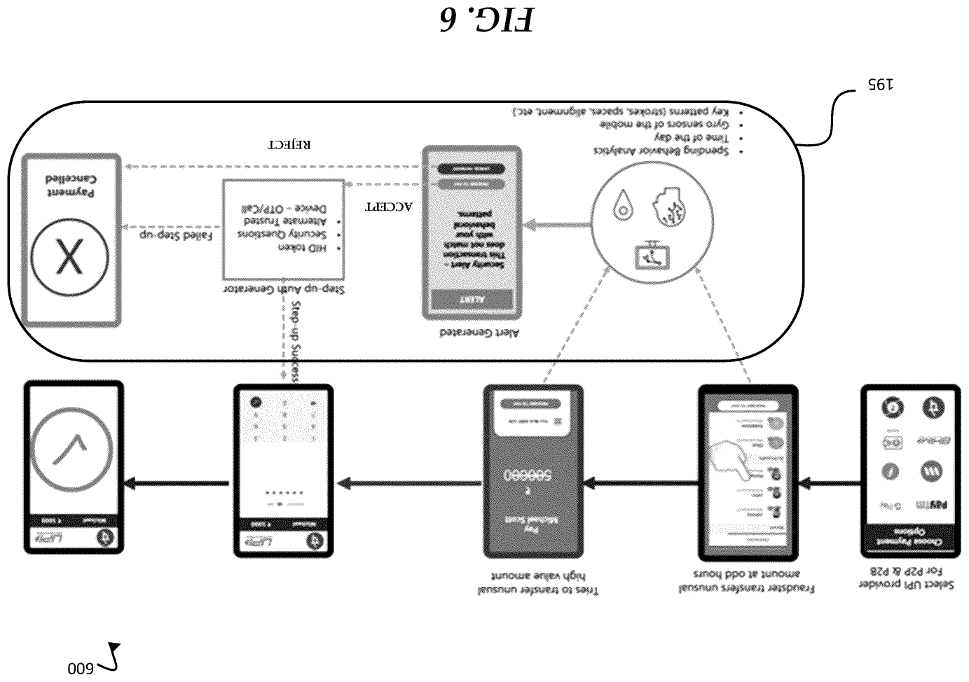

FIG. 6 illustrates an example implementation 600 of payment transaction shield 195 utilized in a UPI-based transaction processing system 100 in accordance with some embodiments. In the example of FIG. 6, the payment transaction shield 195 generated by the payment transaction shield generator 296 has shielded the user of payment application 196 (e.g., a UPI-based payment application) from a payment transaction occurring at non-typical payment transaction hours and at a monetary value typically not utilized by the user of payment application 196. The payment transaction shield 195 has notified the user of the payment application 196 to verify the payment transaction by either proceeding with the payment transaction (e.g., “PROCEED TO PAY”) or cancelling the payment transaction (e.g., “CANCEL PAYMENT”). In FIG. 6, if the user authorizes the payment transaction, payment transaction shield verifies the payment transaction with additional verification processes (e.g., additional security questions, an HID token, alternate trusted device, etc.).

In some embodiments, the communication device 110 utilizes the payment transaction shield 195 to shield the user from unauthorized or unintended payment transactions conducted using the payment application 196 and allows only authorized payment transactions to be conducted using the payment application 196. In some embodiments, utilization of the payment transaction shield, which may be considered a shield-up service, allows for the execution of a self-correcting algorithm by repeatedly alerting the user of the payment application of potentially unauthorized or unintended payment transactions with user friendly communication/notification, as well as by providing system-based intelligence to the user to understand and self-correct the payment transactions. In some embodiments, by identifying the payment transaction failures expeditiously using the payment transaction shield (based on different user or behavior parameters), the payment transaction shield is able to alert a user ahead of an unauthorized or unintended payment transaction to protect his/her financial data. In some embodiments, the payment transaction shield therefore provides better data security and transaction speed for faster and simplified user interaction over prior secured transaction techniques, which do not utilize the payment transaction shield.

In some embodiments, a computer-implemented method, includes determining, at a communication device, whether a user of a payment application on the communication device desires additional security underlying the payment application; when the user of the communication device desires the additional security, generating a payment transaction shield underlying the payment application; ascertaining user-specific information from the payment application; generating, as part of the payment transaction shield, a frontend security framework specific to the user of the payment application; mapping the frontend security framework to the user-specific information; and utilizing the frontend security framework to authorize a payment transaction conducted using the payment application.

In some embodiments, the computer-implemented method further includes performing a behavior-based analysis of the communication device as part of a behavior-based authentication to determine whether to secure the payment transaction.

In some embodiments, the computer-implemented method further includes generating a risk score based upon the behavior-based analysis.

In some embodiments, the computer-implemented method further includes utilizing the risk score to determine whether to allow the payment transaction conducted using the payment application.

In some embodiments of the computer-implemented method, when the risk score is greater than a risk score threshold, the payment transaction conducted by the user using the payment application is authorized.

In some embodiments, the computer-implemented method further includes assessing a spending pattern of the user of the communication device to determine whether to allow the payment transaction conducted using the payment application.

In some embodiments, the computer-implemented method further includes assessing commonly used merchants of the user of the communication device to determine whether to allow the payment transaction conducted using the payment application.

In some embodiments, the computer-implemented method further includes assessing a commonly used persons of the user of the communication device to determine whether to allow the payment transaction conducted using the payment application.

In some embodiments, a system includes a processor; and a non-transitory computer readable medium coupled to the processor, the non-transitory computer readable medium including code that: determines whether a user of a payment application on the communication device desires additional security underlying the payment application; when the user of the communication device desires the additional security, ascertains user-specific information from the payment application; generates a frontend security framework specific to the user of the payment application; maps the frontend security framework to the user-specific information; and utilizes the frontend security framework to secure a payment transaction conducted using the payment application.

In some embodiments of the system, the code performs a behavior-based analysis of the communication device as part of a behavior-based authentication to determine whether to secure the payment transaction.

In some embodiments of the system, the code generates a risk score based upon the behavior-based analysis.

In some embodiments of the system, the code utilizes the risk score to determine whether to allow the payment transaction conducted using the payment application.

In some embodiments of the system, when the risk score is greater than a risk score threshold, the payment transaction conducted by the user using the payment application is authorized.

In some embodiments of the system, the code assesses a spending pattern of the user of the communication device to determine whether to allow the payment transaction conducted using the payment application.

In some embodiments of the system, the code assesses commonly used merchants of the user of the communication device to determine whether to allow the payment transaction conducted using the payment application.

In some embodiments of the system, the code assesses a commonly user person of the user of the communication device to determine whether to allow the payment transaction conducted using the payment application.

In some embodiments, a computer-implemented method includes attaining user-specific information from a user of Unified Payments Interface (UPI)-based payment application; generating a user-specific frontend security framework based upon the user-specific information; overlaying the user-specific security framework over the UPI-based payment application; and utilizing the user-specific security framework to secure a payment transaction utilizing the UPI-based payment application, the user-specific security framework being configured to self-correct the payment transaction based upon user conduct.

In some embodiments, the computer-implemented method further includes performing a behavior-based analysis of the communication device as part of a behavior-based authentication to determine whether to secure the payment transaction.

In some embodiments, the computer-implemented method further includes generating a risk score based upon the behavior-based analysis.

In some embodiments, the computer-implemented method further includes utilizing the risk score to determine whether to allow the payment transaction conducted using the payment application.

In some embodiments, the payment transaction shield generator and methods described herein improve upon existing communication devices and computer systems in that, for example, unlike current communication devices and computer systems, a payment transaction shield is generated by the payment transaction shield generator that, for example, protects a user associated with a payment application from unauthorized or unintended payment transactions conducted using the payment application.

What is claimed is:

1. A computer-implemented method, comprising:
determining, at a communication device, whether a user of a payment application on the communication device desires additional security underlying the payment application;
when the user of the communication device desires the additional security, generating a payment transaction shield underlying the payment application;
ascertaining user-specific information from the payment application;
generating, as part of the payment transaction shield, a frontend security framework specific to the user of the payment application;
mapping the frontend security framework to the user-specific information; and
utilizing the frontend security framework to authorize a payment transaction conducted using the payment application.

2. The computer-implemented method of claim 1, further comprising:
performing a behavior-based analysis of the communication device as part of a behavior-based authentication to determine whether to secure the payment transaction.

3. The computer-implemented method of claim 2, further comprising:
generating a risk score based upon the behavior-based analysis.

4. The computer-implemented method of claim 3, further comprising:
utilizing the risk score to determine whether to allow the payment transaction conducted using the payment application.

5. The computer-implemented method of claim 3, wherein:
when the risk score is greater than a risk score threshold, the payment transaction conducted by the user using the payment application is authorized.

6. The computer-implemented method of claim 4, further comprising:
assessing a spending pattern of the user of the communication device to determine whether to allow the payment transaction conducted using the payment application.

7. The computer-implemented method of claim 5, further comprising:
assessing commonly used merchants of the user of the communication device to determine whether to allow the payment transaction conducted using the payment application.

8. The computer-implemented method of claim 6, further comprising:
assessing a commonly used person of the user of the communication device to determine whether to allow the payment transaction conducted using the payment application.

9. A system, comprising:
a processor; and
a non-transitory computer readable medium coupled to the processor, the non-transitory computer readable medium including code that:
determines whether a user of a payment application on the communication device desires additional security underlying the payment application;
when the user of the communication device desires the additional security, ascertains user-specific information from the payment application;
generates a frontend security framework specific to the user of the payment application;
maps the frontend security framework to the user-specific information; and
utilizes the frontend security framework to secure a payment transaction conducted using the payment application.

10. The system of claim 9, wherein:
the code performs a behavior-based analysis of the communication device as part of a behavior-based authentication to determine whether to secure the payment transaction.

11. The system of claim 10, wherein:
the code generates a risk score based upon the behavior-based analysis.

12. The system of claim 11, wherein:
the code utilizes the risk score to determine whether to allow the payment transaction conducted using the payment application.

13. The system of claim 12, wherein:
when the risk score is greater than a risk score threshold, the payment transaction conducted by the user using the payment application is authorized.

14. The system of claim 13, wherein:
the code assesses a spending pattern of the user of the communication device to determine whether to allow the payment transaction conducted using the payment application.

15. The system of claim 13, wherein:
the code assesses commonly used merchants of the user of the communication device to determine whether to allow the payment transaction conducted using the payment application.

16. The system of claim 13, wherein:
the code assesses a commonly used person of the user of the communication device to determine whether to allow the payment transaction conducted using the payment application.

17. A computer-implemented method, comprising:
attaining user-specific information from a user of Unified Payments Interface (UPI)-based payment application;
generating a user-specific frontend security framework based upon the user-specific information;
overlaying the user-specific security framework over the UPI-based payment application; and
utilizing the user-specific security framework to secure a payment transaction utilizing the UPI-based payment application, the user-specific security framework being configured to self-correct the payment transaction based upon user conduct.

18. The computer-implemented method of claim 17, further comprising:
performing a behavior-based analysis of the communication device as part of a behavior-based authentication to determine whether to secure the payment transaction.

19. The computer-implemented method of claim 18, further comprising:
generating a risk score based upon the behavior-based analysis.

20. The computer-implemented method of claim 19, further comprising:
utilizing the risk score to determine whether to allow the payment transaction conducted using the payment application.
